(19) United States
(12) Patent Application Publication
(10) Pub. No.: US 2024/0348392 A1
(43) Pub. Date: Oct. 17, 2024

(54) METHOD FOR SIDELINK COMMUNICATION AND COMMUNICATION DEVICE

(71) Applicant: GUANGDONG OPPO MOBILE TELECOMMUNICATIONS CORP., LTD., Dongguan (CN)

(72) Inventors: Shichang ZHANG, Dongguan (CN); Zhenshan ZHAO, Dongguan (CN); Teng MA, Dongguan (CN)

(21) Appl. No.: 18/752,236

(22) Filed: Jun. 24, 2024

Related U.S. Application Data
(63) Continuation of application No. PCT/CN2021/142588, filed on Dec. 29, 2021.

(51) Int. Cl. H04L 5/00; H04W 72/25

(52) U.S. Cl. CPC H04L 5/0048; H04W 72/25

(57) ABSTRACT

A method for sidelink communication and a communication device are provided. The method for sidelink communication includes configuring sidelink positioning reference signal (PRS)-related information. The sidelink PRS-related information includes at least one of: a sidelink PRS-related signal or a sidelink PRS-related channel; or a sidelink PRS resource pool.

### CROSS-REFERENCE TO RELATED APPLICATION(S)

This application is a continuation of International Application No. PCT/CN2021/142588, filed Dec. 29, 2021, the entire disclosure of which is hereby incorporated by reference.

### TECHNICAL FIELD

The disclosure relates to the field of communication, and more particularly to a method for sidelink communication and a communication device.

### BACKGROUND

Sidelink (SL) communication includes device to device (D2D) communication. Positioning based on SL includes “new radio (NR) positioning enhancement”, “scenarios and requirements of in-coverage, partial coverage, and out-of-coverage NR positioning use cases”, etc. More accurate positioning is required for SL.

### SUMMARY

Embodiments of the disclosure provide a method for sidelink (SL) communication and a communication device.

Embodiments of the disclosure provide a method for SL communication including configuring SL positioning reference signal (PRS)-related information. The sidelink PRS-related information includes at least one of: a sidelink PRS-related signal or a sidelink PRS-related channel; or a sidelink PRS resource pool.

Embodiments of the disclosure provide a communication device that includes a processor and a memory storing a computer program which, when executed by the processor, causes the communication device to configure SL PRS-related information. The sidelink PRS-related information includes at least one of: a sidelink PRS-related signal or a sidelink PRS-related channel; or a sidelink PRS resource pool.

Other features and aspects of the disclosed features will become apparent from the following detailed description, taken in conjunction with the accompanying drawings, which illustrate, by way of example, the features in accordance with embodiments of the disclosure. The summary is not intended to limit the scope of any embodiment described herein.

### BRIEF DESCRIPTION OF THE DRAWINGS

FIG. 1 is a schematic diagram of an application scenario according to embodiments of the disclosure.

FIG. 2a is a schematic diagram illustrating a system frame number (SFN) period in long term evaluation-vehicle to everything (LTE-V2X).

FIG. 2b is a schematic diagram illustrating determination of a resource pool from remaining subframes in LTE-V2X.

FIG. 3 is a schematic diagram illustrating a manner of multiplexing a physical sidelink control channel (PSCCH) and a physical sidelink shared channel (PSSCH) in an LTE-V2X system and a manner of multiplexing a PSCCH and a PSSCH in a new radio-vehicle to everything (NR-V2X) system.

FIG. 4 is a schematic diagram illustrating PSCCH and PSSCH resource pools in NR-V2X.

FIG. 5 is a schematic structural diagram illustrating slots in an NR system.

FIG. 6 is a schematic diagram illustrating some of symbols in a slot being used for sidelink transmission.

FIG. 7 is a schematic flow chart of a method for sidelink communication according to an embodiment of the disclosure.

FIG. 8 is a schematic diagram illustrating different orthogonal frequency division multiplexing (OFDM) symbols in a same slot being configured as different resource pools.

FIG. 9 is a schematic diagram illustrating a sidelink positioning reference signal (PRS) resource pool occupying frequency domain resources not used for synchronization signals configured on a sidelink bandwidth part (BWP).

FIG. 10 is a schematic block diagram of a communication device according to an embodiment of the disclosure.

FIG. 11 is a schematic block diagram of a communication device according to embodiments of the disclosure.

FIG. 12 is a schematic block diagram of a chip according to embodiments of the disclosure.

FIG. 13 is a schematic block diagram of a communication system according to embodiments of the present disclosure.

### DETAILED DESCRIPTION

The following will illustrate technical solutions of embodiments of the disclosure with reference to the accompanying drawings of embodiments of the disclosure.

The technical solutions in embodiments of the disclosure can be applicable to various communication systems, for example, a global system of mobile communication (GSM), a code division multiple access (CDMA) system, a wideband code division multiple access (WCDMA) system, a general packet radio service (GPRS) system, a long term evolution (LTE) system, an advanced LTE (LTE-A) system, a new radio (NR) system, an evolved system of the NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), a wireless fidelity (Wi-Fi), a 5th-generation (5G) system, or other communication systems.

Generally speaking, a conventional communication system supports a limited number of connections and therefore is easy to implement. However, with the development of communication technology, a mobile communication system not only supports conventional communication but also supports, for example, device to device (D2D) communication, machine-to-machine (M2M) communication, machine-type communication (MTC), and vehicle-to-vehicle (V2V) communication. Embodiments herein can also be applicable to these communication systems.

In a possible implementation manner, a communication system in embodiments of the disclosure can be applicable to a carrier aggregation (CA) scenario, a dual connectivity (DC) scenario, and a standalone (SA) scenario.

In a possible implementation manner, the communication system in embodiments of the disclosure can be applicable to an unlicensed spectrum, where the unlicensed spectrum can also be regarded as a shared spectrum. Alternatively, the communication system in embodiments of the disclosure can also be applicable to a licensed spectrum, where the licensed spectrum can also be regarded as an unshared spectrum.

In embodiments of the disclosure, each embodiment is illustrated in conjunction with a network device and a terminal device, where the terminal device may also be called a user equipment (UE), an access terminal, a subscriber unit, a subscriber station, a mobile station, a mobile platform, a remote station, a remote terminal, a mobile device, a user terminal, a terminal, a wireless communication device, a user agent, a user apparatus, etc.

The terminal device may also be a station (ST) in the WLAN, a cellular radio telephone, a cordless telephone, a session initiation protocol (SIP) telephone, a wireless local loop (WLL) station, or a personal digital assistant (PDA). The terminal device may also be a device with wireless communication functions such as a handheld device, a computing device, other processing devices coupled with a wireless modem, an in-vehicle device, a wearable device, or a terminal device in a next-generation communication system such as an NR network, a terminal device in a future evolved public land mobile network (PLMN), etc.

In embodiments of the disclosure, the terminal device can be deployed on land, including indoor or outdoor, handheld, wearable, or vehicle-mounted; on water (e.g., a ship); and also in the air (e.g., an aircraft, a balloon, and a satellite).

In embodiments of the disclosure, the terminal device may be a mobile phone, a pad, a computer with wireless transceiving functions, a terminal device for virtual reality (VR), a terminal device for augmented reality (AR), a wireless terminal device in industrial control, a wireless terminal device in self-driving, a wireless terminal device in remote medical, a wireless terminal device in smart grid, a wireless terminal device in transportation safety, a wireless terminal device in smart city, a wireless terminal device in smart home, etc.

As an example but not a limitation, in embodiments of the disclosure, the terminal device may also be a wearable device. The wearable device can also be called a wearable smart device, which is a collective name of wearable devices intelligently designed and developed by applying wearable technology to daily wear, such as glasses, gloves, watches, clothing, shoes, etc. The wearable device is a portable device that can be worn directly on the body or integrated into clothing or accessories of a user. The wearable device not only is a hardware device but also can realize powerful functions through software support, data interaction, and cloud interaction. Broadly speaking, the wearable smart device includes a device that has full functions and a large size and can realize all or part of functions without relying on a smart phone, e.g., a smart watch, smart glasses, or the like, and includes a device that only focuses on a certain application function and needs to be used with other devices such as a smart phone, e.g., all kinds of smart bracelets and smart jewellery for physical sign monitoring or the like.

In embodiments of the disclosure, the network device may be a device used to communicate with a mobile device. The network device may be an access point (AP) in the WLAN, a base transceiver station (BTS) in the GSM or CDMA system, a NodeB (NB) in the WCDMA system, or an evolved NodeB (eNB or eNodeB) in the LTE system. Alternatively, the network device may also be a relay station, an AP, an in-vehicle device, a wearable device, a network device or a generation NodeB (gNB) in the NR network, a network device in the future evolved PLMN, or a network device in the NTN network.

As an example but not a limitation, in embodiments of the disclosure, the network device can have mobility, e.g., the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. Alternatively, the network device may also be a base station deployed on land, on water, or on other locations.

In embodiments of the disclosure, the network device can provide a service for a cell, and the terminal device can communicate with the network device through transmission resources (e.g., frequency-domain resources or spectrum resources) for the cell, where the cell may be a cell corresponding to the network device (e.g., a base station). The cell may belong to a macro base station or a base station corresponding to a small cell, where the small cell may include a metro cell, a micro cell, a pico cell, a femto cell, or the like. These small cells have features of small coverage ranges and low transmission power and are suitable for providing high-speed data transmission services.

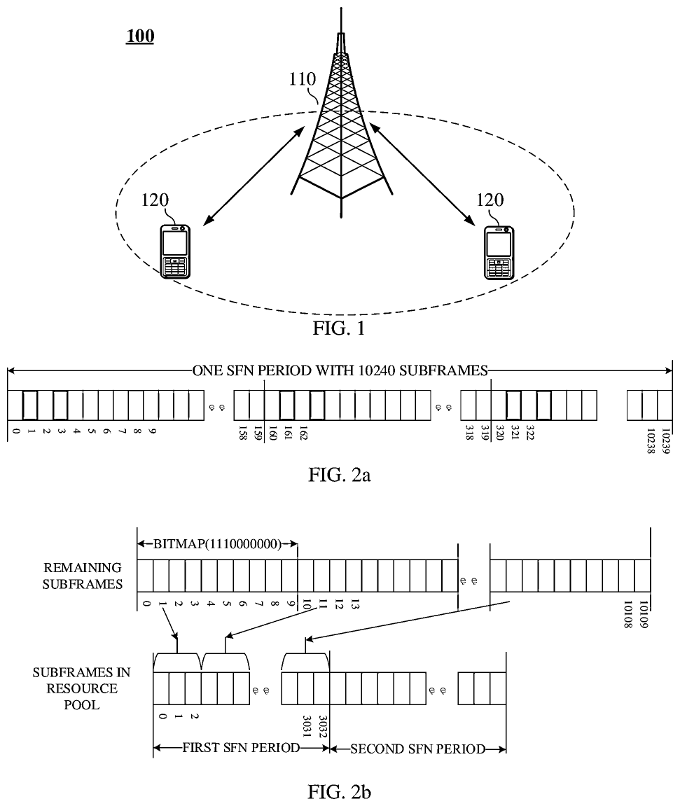

FIG. 1 exemplarily illustrates a communication system 100. The communication system 100 includes a network device 110 and two terminal devices 120. In a possible implementation manner, the communication system 100 may include multiple network device 110, and the other number of terminal device 120 may be included in a coverage range of each of the multiple network device 110, which will not be limited in embodiments of the disclosure.

In a possible implementation manner, the communication 100 may further include other network entities such as a mobility management entity (MME), an access and mobility management function (AMF), etc., and embodiments of the disclosure are not limited in this regard.

The network device further includes an access network device and a core network device. That is, the wireless communication system further includes multiple core network devices configured to perform communication with the access network device. The access network device may be an evolutional node B (referred to as eNB or e-NodeB), a micro station (also referred to as “small station”), a pico station, an access point (AP), a transmission point (TP), or a new generation NodeB, gNodeB), etc., in a long-term evolution (LTE) system, a next radio (NR) system, or an authorized auxiliary access long-term evolution (LAA-LTE).

It is understood that, a device with a communication function in a network/system in embodiments of the disclosure can be called a communication device. Taking the communication system 100 illustrated in FIG. 1 as an example, communication devices can include the network device and the terminal device that have communication functions, and the network device and the terminal device may be the devices in embodiments of the disclosure, which will not be repeated herein. The communication devices can further include other devices in the communication system 100, for example, a network controller, an MME, or other network entities, which will not be limited in embodiments of the disclosure.

It is understood that, the terms “system” and “network” in this disclosure are often used interchangeably. The term “and/or” in this disclosure is simply an illustration of an association relationship of associated objects, indicating that three relationships may exist, for example, A and/or B, which may indicate the existence of A alone, A and B together, and B alone. In addition, the character “/” in this disclosure generally indicates that associated objects are in an “or” relationship.

It is understood that, the “indication” referred to in embodiments of the disclosure may be a direct indication, an indirect indication, or an indication indicating an associated relation. For example, A indicates B, which can mean that A indicates B directly, e.g., B can be obtained through A, can also mean that A indicates B indirectly, e.g., A indicates C, and B can be obtained through C, or can further mean that A and B have an associated relation.

In illustration of embodiments of the disclosure, the term “correspondence” may represent a direct correspondence or indirect correspondence between the two, may also represent an associated relation between the two, or may further represent a relation of indicating and being indicated, a relation of configuring and being configured, or other relations.

In order for a better understanding of technical solutions of embodiments of the disclosure, the related art of the disclosure will be described below. The following related art as an optional scheme can be arbitrarily combined with the technical solutions of embodiments of the disclosure, which shall all belong to the protection scope of embodiments of the disclosure.

Technical solutions of embodiments of the disclosure can be applied to sidelink (SL) communication. SL communication may include vehicle to everything (V2X). V2X includes long term evaluation-vehicle to everything (LTE-V2X), new radio-vehicle to everything (NR-V2X), etc. The following introduces various manners for determining an SL communication resource pool.

### 1. Manner for Determining a Resource Pool in LTE-V2X.

In LTE-V2X, a resource pool is determined in a system frame number (SFN) period or a direct frame number (DFN) period. An SFN period contains 10240 subframes, which are subframes 0 to 10239. Except for synchronization subframes, downlink subframes, special subframes (i.e., downlink subframes and special subframes in time division duplex (TDD)), and reserved subframes, remaining subframes are numbered as (t₀^{SL}, t₁^{SL}, . . . , t_{T}_{ₘₐₓ}^{SL}). The number of the remaining subframes is divisible by L_{bitmap}. Bitmap (b₀, b₁, . . . , b_{L}_{_{bitmap}}) is repeated periodically for the remaining subframes. A bit of 1 indicates that a subframe corresponding to the bit in the remaining subframes belongs to the resource pool, otherwise, the subframe corresponding to the bit does not belong to the resource pool.

As illustrated in FIG. 2a, an SFN period (or a DFN period) contains 10240 subframes, and a synchronization signal period is 160 ms. A synchronization period contains 2 synchronization subframes. Therefore, an SFN period contains 128 synchronization subframes, and the length of a bitmap indicating time domain resources in the resource pool is 10 bits. Two reserved subframes are needed, and thus the number of the remaining subframes is 10110 (10240−128−2=10110) divisible by the length of the bitmap (i.e., 10 bits). As illustrated in FIG. 2b, the remaining subframes are renumbered as 0, 1, 2, . . . , 10109, the first three bits of a bitmap are all 1, and the rest seven bits are all 0. That is, in each 10 subframes in the remaining subframes, the first three subframes belong to the resource pool, and the rest subframes do not belong to the resource pool. A bitmap needs to be repeated 1011 times to indicate whether each subframe in the remaining subframes belongs to the resource pool. 3 subframes in each bitmap period belong to the resource pool, therefore a total of 3033 subframes belong to the resource pool in an SFN period. For example, the first SFN period and the second SFN period each have 3033 subframes that belong to the resource pool.

### 2. Manner for Determining a Resource Pool in NR-V2X.

Compared with the LTE-V2X system, the delay is relatively lower in NR-V2X system. Therefore, a manner of multiplexing a physical SL control channel (PSCCH) and a physical SL shared channel (PSSCH) in the NR-V2X system is redesigned compared with the LTE-V2X system. In the LTE-V2X system, a PSCCH and a PSSCH are multiplexed in frequency division multiplexing (FDM). A terminal performs PSSCH detection after PSCCH reception, and thus delay is increased. In the NR-V2X system, the PSCCH and the PSSCH are multiplexed in a manner illustrated in FIG. 3.

In NR-V2X, besides an automatic gain control (AGC) symbol, the PSCCH occupies 2 or 3 orthogonal frequency division multiplexing (OFDM) symbols. The time domain position of the PSCCH starts from the second time domain symbol (the first time domain symbol is the ACG symbol) in time domain symbols available for SL transmission in a slot, and the number of physical resource blocks (PRB) occupied by the PSCCH in the frequency domain is configurable.

### (1) Determination of Frequency Resources.

Similar to LTE-V2X, in NR-V2X, frequency domain resources in a resource pool are contiguous, and frequency resource allocation is in subchannel granularity. The number of PRBs of a subchannel may be {10,12,15,20,50,75,100}. In NR-V2X, the smallest subchannel contains 10 PRBs, much larger than the size of the smallest subchannel, 4 PRBs, in LTE-V2X. The main reason is as follows. In NR-V2X, a frequency domain resource for a PSCCH is located in the first subchannel for a PSSCH associated with the PSCCH, the size of the frequency domain resource for the PSCCH is smaller than or equal to the size of a subchannel for the PSSCH, and a time domain resource for the PSCCH includes two or three OFDM symbols. If a subchannel is configured to be relatively small, there may be few resources available for the PSCCH and bit rate is increased, thus reducing performance of PSCCH detection. In NR-V2X, the size of a subchannel for the PSCCH and the size of a frequency domain resource for the PSCCH are configured independently, but it needs to be ensured that the size of the frequency domain resource for the PSCCH is smaller than or equal to the size of the subchannel for the PSSCH. The following configuration parameters in configuration information of a resource pool in NR-V2X are used for determining frequency domain resources in a PSCCH resource pool and frequency domain resources in a PSSCH resource pool.

sl-SubchannelSize: sl-SubchannelSize indicates the number of contiguous PRBs of a subchannel in a resource pool, where the value range of sl-SubchannelSize is {10,12,15,20,50,75,100} PRBs.

sl-NumSubchannel: sl-NumSubchannel indicates the number of subchannels in a resource pool.

sl-StartRB-Subchannel: sl-StartRB-Subchannel indicates an index of a starting PRB of the first subchannel in a resource pool.

sl-FreqResourcePSCCH: sl-FreqResourcePSCCH indicates the size of a frequency domain resource for a PSCCH, where the value range of the size of the frequency domain resource for the PSCCH is {10,12,15,20,25} PRBs.

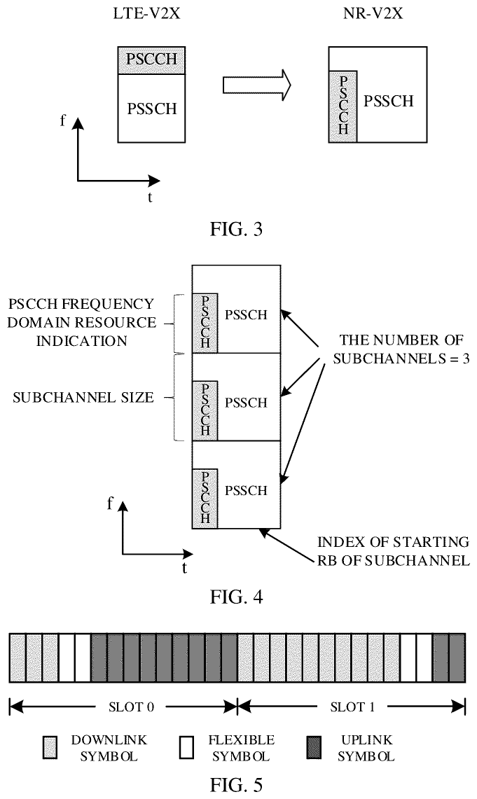

In NR-V2X, a frequency domain starting position of a PSCCH is aligned with a frequency domain starting position of the first subchannel for a PSSCH associated with the PSCCH. Therefore, the starting position of each subchannel for the PSSCH may be a possible frequency domain starting position of the PSCCH. As illustrated in FIG. 4, according to the foregoing parameters, a frequency domain range of a PSCCH resource pool and a frequency domain range of a PSSCH resource pool can be determined.

### (2) Determination of Time Domain Resources.

In NR-V2X, PSCCH/PSSCH transmission is slot-based. For example, in one slot, merely one PSCCH/PSSCH can be transmitted, and transmission of multiple PSCCH/PSSCHs in time division multiplexing (TDM) in one slot is not supported. PSCCH/PSSCHs for different users can be multiplexed in FDM in one slot. In NR-V2X, time domain resources for a PSSCH are in slot granularity. Different from that a PSSCH occupies all time domain symbols in one subframe in LTE-V2X, in NR-V2X, a PSSCH may occupy some of the symbols in a slot. The main reason is as follows. In the LTE system, uplink transmission or downlink transmission is in subframe granularity, therefore SL transmission is also in subframe granularity (special subframes in a TDD system are not used for SL transmission). The NR system uses a flexible slot structure, that is, a slot contains uplink symbols and downlink symbols, so as to achieve more flexible scheduling and reduce the delay. FIG. 5 exemplarily illustrates a subframe in the NR system, where a slot may contain downlink (DL) symbols, uplink (UL) symbols, and flexible symbols. DL symbols are located at the start of a slot. UL symbols are located at the end of a slot. Flexible symbols are located between DL symbols and UL symbols. The number of each of the types of symbols in each slot is configurable.

As mentioned above, an SL transmission system can share a carrier with a cellular system, and in this case, SL transmission can only use UL transmission resources in the cellular system. For NR-V2X, if SL transmission still needs to occupy all time domain symbols in one slot, a network needs to configure UL-only slots for SL transmission, which may adversely affect UL/DL data transmission in the NR system and reduce system performance. Therefore, in NR-V2X, it is supported that some of the symbols in a slot are used for SL transmission, that is, some of the UL symbols in a slot are used for SL transmission. In addition, considering that SL transmission occupies the AGC symbol and the guard period (GP) symbol, if the number of UL symbols available for SL transmission is relatively small, except the AGC symbol and the GP symbol, the number of remaining symbols available for valid data transmission is relatively small, resulting in low resource utilization. Therefore, in NR-V2X, SL transmission occupies at least 7 time domain symbols (including the GP symbol). In the case where an SL transmission system uses a dedicated carrier, the SL transmission system does not share transmission resources with other systems, therefore all symbols in a slot can be configured for SL transmission.

In NR-V2X, the starting symbol of and the length of time domain symbols for SL transmission in a slot are configured via sl-StartSymbol and sl-LengthSymbols, the last symbol in time domain symbols for SL transmission is used as a GP, and a PSSCH and PSCCH can only use the rest time domain symbols. However, if a slot is configured with transmission resources for a physical SL feedback channel (PSFCH), the PSSCH and PSCCH cannot occupy time domain symbols for PSFCH transmission, and cannot occupy the AGC symbol before the time domain symbols for PSFCH transmission and the GP symbol (as illustrated in FIGS. 4 to 5).

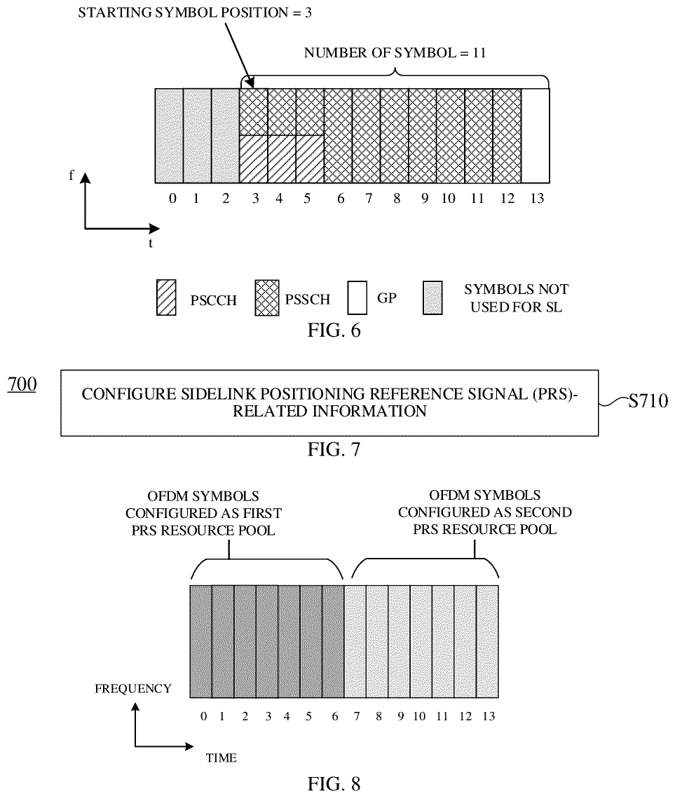

As illustrated in FIG. 6, a network configures that the starting symbol is symbol 3 and the number of symbols is 11, that is, 11 time domain symbols starting from symbol 3 in a slot are available for SL transmission. Symbol 3 is generally used as the AGC symbol, symbol 13 is used as a GP, and the rest symbols are available for PSCCH transmission and PSSCH transmission. A PSCCH occupies 2 time domain symbols. Since data in the AGC symbol is a duplicate of data in the second SL symbol, the first SL symbol also contains PSCCH data.

In the NR-V2X system, time domain resources in a resource pool are also indicated via a bitmap. Considering the flexible slot structure in the NR system, the length of the bitmap is extended. The supported bitmap length range is [10:160]. A manner of determining, via a bitmap, positions of slots that belong to a resource pool in an SFN period is the same as that in LTE-V2X except for the following aspects.

The total number of slots in an SFN period is 10240×2^{μ}, where parameter μ is related to subcarrier spacing.

In time domain symbols Y, Y+1, Y+2, . . . , Y+X−1 in a slot, if at least one time domain symbol is not configured as a UL symbol via TDD-UL-DL-ConfigCommon signaling from a network, the slot cannot be used for SL transmission. Y represents sl-StartSymbol and X represents sl-LengthSymbols.

### 3. SL-Based Positioning.

3GPP radio access network (RAN) did research on “NR positioning enhancement” and “scenarios and requirements of in-coverage, partial coverage, and out-of-coverage NR positioning use cases”. Research on “scenarios and requirements of in-coverage, partial coverage, and out-of-coverage NR positioning use cases” focuses on V2X and public security use cases. In addition, 3GPP first system architecture workgroup (SA1) formulated requirements on “distance-measurement-based service” and formulated positioning accuracy requirements for the use of the Industrial interest of Things (IIoT) in out-of-coverage scenarios. 3GPP needs to research and develop a solution for SL-based positioning to support the use cases, scenarios, and requirements in these activities.

If positioning reference signal (PRS) transmission or reception is supported on SL, a resource pool for PRS transmission or a resource pool for PRS reception needs to be determined.

FIG. 7 is a schematic flow chart of method 700 for SL communication according to an embodiment of the disclosure. The method includes at least some of the following.

At S710, SL PRS-related information is configured.

In an embodiment, a manner for configuring the SL PRS-related information includes at least one of: configuring via a network device, configuring via a peer device, or pre-configuring.

In an embodiment, the network device can configure the SL PRS-related information. For example, the network device can transmit PRS configuration information to a first device and/or a second device. The second device may be a peer device that performs SL communication with the first device. The first device and/or the second device determine respective SL PRS-related information based on the received PRS configuration information.

In an embodiment, the first device and/or the second device can configure respective SL PRS-related information. For example, the first device and/or the second device can receive the PRS configuration information from the network device and determine the SL PRS-related information for the first device based on the PRS configuration information. For another example, the first device can receive the PRS configuration information from the second device and determine the SL PRS-related information for the first device based on the PRS configuration information. For another example, the first device can determine the SL PRS-related information for the first device based on pre-configured information. For another example, the second device can receive the PRS configuration information from the first device and determine the SL PRS-related information for the second device based on the PRS configuration information. For another example, the second device can determine the SL PRS-related information for the second device based on the pre-configured information.

In an embodiment, the SL PRS-related information includes at least one of: an SL PRS-related signal or an SL PRS-related channel, for example, a PRS, an SL channel indicating PRS transmission, etc.; or an SL PRS resource pool.

In an embodiment, the SL PRS resource pool includes at least one of: a resource pool for SL PRS transmission, where the resource pool for SL PRS transmission is configured for transmission of the SL PRS-related signal or the SL PRS-related channel, or a resource pool for SL PRS reception, where the resource pool for SL PRS reception is configured for reception of the SL PRS-related signal or the SL PRS-related channel.

For example, the SL PRS-related information for the first device determined by the first device includes the resource pool for SL PRS transmission. The first device can use a resource(s) in the resource pool for SL PRS transmission to transmit the SL PRS-related signal or the SL PRS-related channel to the second device.

For another example, the SL PRS-related information for the second device determined by the second device includes the resource pool for SL PRS reception. The second device can use a resource(s) in the resource pool for SL PRS reception to receive the SL PRS-related signal or the SL PRS-related channel from the first device.

In an embodiment, time frequency resources occupied by the SL PRS resource pool are different from time frequency resources occupied by an SL communication resource pool. For example, time frequency resources occupied by the resource pool for SL PRS transmission are different from the time frequency resources occupied by the SL communication resource pool. For another example, time frequency resources occupied by the resource pool for SL PRS reception are different from the time frequency resources occupied by the SL communication resource pool.

In an embodiment, slots in the SL PRS resource pool are different from slots in the SL communication resource pool. For example, slots in the resource pool for SL PRS transmission are different from the slots in the SL communication resource pool. For another example, slots in the resource pool for SL PRS reception are different from the slots in the SL communication resource pool.

In an embodiment, the SL PRS resource pool and the SL communication resource pool contain OFDM symbols in a same slot, where the OFDM symbols in the SL PRS resource pool are different from the OFDM symbols in the SL communication resource pool. For example, the resource pool for SL PRS transmission and the SL communication resource pool contain OFDM symbols in a same slot, where the OFDM symbols in the resource pool for SL PRS transmission are different from the OFDM symbols in the SL communication resource pool. For another example, the resource pool for SL PRS reception and the SL communication resource pool contain OFDM symbols in a same slot, where the OFDM symbols in the resource pool for SL PRS reception are different from the OFDM symbols in the SL communication resource pool.

In an embodiment, in a slot, the number of OFDM symbols available for SL PRS-related signal or channel transmission is less than the number of OFDM symbols available for PSSCH transmission.

In an embodiment, in a slot, the number of OFDM symbols available for SL PRS-related signal or channel reception is less than the number of OFDM symbols available for PSSCH reception.

For example, in slot n, for the first device, the number of OFDM symbols available for SL PRS-related signal or channel transmission is 2, and the number of OFDM symbols available for PSSCH transmission is 4. For another example, in slot n+1, for the second device, the OFDM symbols available for SL PRS-related signal or channel reception is 2, and the number of OFDM symbols available for PSSCH reception is 4.

In an embodiment, on an SL bandwidth part (BWP) where the SL PRS resource pool is located, in a slot, the starting OFDM symbol of and the length (i.e., the number) of OFDM symbols available for SL PRS-related signal or channel transmission are configured individually via dedicated signaling.

In an embodiment, on an SL BWP where the SL PRS resource pool is located, in a slot, the starting OFDM symbol of and the length of OFDM symbols available for SL PRS-related signal or channel reception are configured individually via dedicated signaling.

In embodiments of the disclosure, dedicated signaling may be dedicatedly for configuring the resource pool for SL PRS transmission and/or the resource pool for SL PRS reception.

In an embodiment, in a slot, OFDM symbols available for SL PRS-related signal or channel transmission are different from OFDM symbols available for SL communication configured on the SL BWP.

In an embodiment, in a slot, OFDM symbols available for SL PRS-related signal or channel reception are different from OFDM symbols available for SL communication configured on the SL BWP.

In an embodiment, in the case where multiple SL PRS resource pools are configured on the SL BWP, different SL PRS resource pools occupy different frequency domain resources in a same slot or a same OFDM symbol.

For example, resource pool A1 for SL PRS transmission and resource pool A2 for SL PRS transmission for the first device are configured on the SL BWP. The resource pool A1 for SL PRS transmission and the resource pool A2 for SL PRS transmission occupy frequency domain resources in a same slot, where frequency domain resources occupied by the resource pool A1 for SL PRS transmission are different from frequency domain resources occupied by the resource pool A2 for SL PRS transmission.

For another example, resource pool A3 for SL PRS transmission and resource pool A4 for SL PRS transmission for the first device are configured on the SL BWP. The resource pool A3 for SL PRS transmission and the resource pool A4 for SL PRS transmission occupy frequency domain resources in a same OFDM symbol, where frequency domain resources occupied by the resource pool A3 for SL PRS transmission are different from frequency domain resources occupied by the resource pool A4 for SL PRS transmission.

For another example, resource pool B1 for SL PRS reception and resource pool B2 for SL PRS reception for the second device are configured on the SL BWP. The resource pool B1 for SL PRS reception and the resource pool B2 for SL PRS reception occupy frequency domain resources in a same slot, where frequency domain resources occupied by the resource pool B1 for SL PRS reception are different from frequency domain resources occupied by the resource pool B2 for SL PRS reception.

For another example, resource pool B3 for SL PRS reception and resource pool B4 for SL PRS reception for the second device are configured on the SL BWP. The resource pool B3 for SL PRS reception and the resource pool B4 for SL PRS reception occupy frequency domain resources in a same OFDM symbol, where frequency domain resources occupied by the resource pool B3 for SL PRS reception are different from frequency domain resources occupied by the resource pool B4 for SL PRS reception.

In an embodiment, in the case where multiple SL PRS resource pools are configured on the SL BWP, different SL PRS resource pools occupy different time domain resources.

For example, in the case where multiple resource pools for SL PRS transmission for the first device are configured on the SL BWP, different resource pools for SL PRS transmission occupy different time domain resources.

For another example, in the case where multiple resource pools for SL PRS reception for the second device are configured on the SL BWP, different resource pools for SL PRS reception occupy different time domain resources.

In an embodiment, different SL PRS resource pools occupy different OFDM symbols in a same slot, and the different OFDM symbols are configured via parameters for configuring the starting OFDM symbol of and the length of the different OFDM symbols.

For example, different resource pools for SL PRS transmission for the first device occupy different OFDM symbols in a same slot.

For another example, different resource pools for SL PRS reception for the second device occupy different OFDM symbols in a same slot.

In an embodiment, the SL PRS resource pool and the SL BWP where the SL PRS resource pool is located occupy same frequency domain resources.

For example, the resource pool for SL PRS transmission for the first device and an SL BWP where the resource pool for SL PRS transmission for the first device is located occupy same frequency domain resources.

For another example, the resource pool for SL PRS reception for the second device and an SL BWP where the resource pool for SL PRS reception for the second device is located occupy same frequency domain resources.

In an embodiment, the SL PRS resource pool occupies synchronization signal slots. For example, the resource pool for SL PRS transmission for the first device occupies the synchronization signal slots. For another example, the resource pool for SL PRS reception for the second device occupies the synchronization signal slots.

In an embodiment, the SL PRS resource pool occupies some or all of slots for SL synchronization signal transmission configured on an SL BWP. For example, the resource pool for SL PRS transmission for the first device occupies some or all of the slots for SL synchronization signal transmission configured on an SL BWP.

In an embodiment, the SL PRS resource pool contains synchronization signal subframes for synchronization signal transmission. For example, the resource pool for SL PRS transmission for the first device contains synchronization signal subframes for synchronization signal transmission.

In an embodiment, the SL PRS resource pool occupies some or all of slots for SL synchronization signal reception configured on an SL BWP. For example, the resource pool for SL PRS reception for the second device occupies some or all of the slots for SL synchronization signal reception configured on an SL BWP.

In an embodiment, the SL PRS resource pool contains synchronization signal subframes for synchronization signal reception. For example, the resource pool for SL PRS reception for the second device contains synchronization signal subframes for synchronization signal reception.

In an embodiment, the SL PRS resource pool contains all synchronization signal subframes. For example, the resource pool for SL PRS transmission for the first device contains all synchronization signal subframes. For another example, the resource pool for SL PRS reception for the second device contains all synchronization signal subframes.

In an embodiment, the SL PRS resource pool occupies frequency domain resources not used for SL synchronization signal transmission configured on an SL BWP where the SL PRS resource pool is located.

In an embodiment, the SL PRS resource pool occupies frequency domain resources not used for SL synchronization signal reception configured on an SL BWP where the SL PRS resource pool is located.

For example, the resource pool for SL PRS transmission for the first device occupies frequency domain resources not used for SL synchronization signal transmission configured on an SL BWP where the resource pool for SL PRS transmission is located. For another example, the resource pool for SL PRS reception for the second device occupies frequency domain resources not used for SL synchronization reception configured on an SL BWP where the resource pool for SL PRS reception is located.

In an embodiment, in a slot within the SL PRS resource pool, OFDM symbols available for SL PRS-related signal or channel transmission are the same as configuration for SL communication on an SL BWP.

In an embodiment, in a slot within the SL PRS resource pool, OFDM symbols available for SL PRS-related signal or channel reception are the same as configuration for SL communication on an SL BWP.

For example, in a slot within the resource pool for SL PRS transmission for the first device, OFDM symbols available for SL PRS-related signal or channel transmission are the same as configuration for SL communication on an SL BWP. For another example, in a slot within the resource pool for SL PRS-related signal or channel reception for the second device, OFDM symbols available for SL PRS-related signal or channel reception are the same as configuration for SL communication on an SL BWP.

In an embodiment, in the case where an SL BWP where the SL PRS resource pool is located is configured with synchronization slots for synchronization signal transmission, some or all of the synchronization slots are mapped to a bitmap for configuring the SL PRS resource pool.

In an embodiment, in the case where an SL BWP where the SL PRS resource pool is located is configured with synchronization slots for synchronization signal reception, some or all of the synchronization slots are mapped to a bitmap for configuring the SL PRS resource pool.

For example, in the case where an SL BWP where the resource pool for SL PRS transmission for the first device is located is configured with synchronization slots for synchronization signal transmission, some or all of the synchronization slots are mapped to a bitmap for configuring the resource pool for SL PRS transmission. For another example, in the case where an SL BWP where the resource pool for SL PRS reception for the second device is located is configured with synchronization slots for synchronization signal reception, some or all of the synchronization slots are mapped to a bitmap for configuring the resource pool for SL PRS reception.

In an embodiment, the SL PRS resource pool occupies reserved slots. For example, the resource pool for SL PRS transmission for the first device occupies reserved slots. For another example, the resource pool for SL PRS reception for the second device occupies reserved slots.

In an embodiment, the SL PRS resource pool occupies some or all of reserved slots configured in a process of determining an SL communication resource pool. For example, the resource pool for SL PRS transmission for the first device occupies some or all of the reserved slots configured in a process of determining an SL communication resource pool. For another example, the resource pool for SL PRS reception for the second device occupies some or all of reserved slots configured in a process of determining an SL communication resource pool.

In an embodiment, in the case where the SL PRS resource pool occupies some of the reserved slots configured in the process of determining the SL communication resource pool, a bitmap for configuring the SL PRS resource pool indicates reserved slots configured for the SL PRS resource pool. For example, in the case where the resource pool for SL PRS transmission for the first device occupies some of the reserved slots configured in the process of determining the SL communication resource pool, a bitmap for configuring the resource pool for SL PRS transmission indicates reserved slots configured for the resource pool for SL PRS transmission. For another example, in the case where the resource pool for SL PRS reception for the second device occupies some of the reserved slots configured in the process of determining the SL communication resource pool, a bitmap for configuring the resource pool for SL PRS reception indicates reserved slots configured for the resource pool for SL PRS reception.

In an embodiment, the SL PRS resource pool and an SL communication resource pool occupy same frequency domain resources. For example, in the case where the SL PRS resource pool occupies the reserved slots, the resource pool for SL PRS transmission and an SL communication resource pool occupy same frequency domain resources, or the resource pool for SL PRS reception and an SL communication resource pool occupy same frequency domain resources.

In an embodiment, at least one of the following is frequency-division multiplexed: different SL PRS resource pools; or, the SL PRS resource pool and the SL communication resource pool.

In an embodiment, in the case where the SL PRS resource pool occupies the reserved slots, different SL PRS resource pools are frequency-division multiplexed. For example, the resource pool A1 for SL PRS transmission and the resource pool A2 for SL PRS transmission are frequency-division multiplexed. For another example, the resource pool B1 for SL PRS reception and the resource pool B2 for SL PRS reception are frequency-division multiplexed.

In an embodiment, in the case where the SL PRS resource pool occupies the reserved slots, the SL PRS resource pool and the SL communication resource pool are frequency-division multiplexed. For example, the resource pool A1 for SL PRS transmission and the SL communication resource pool are frequency-division multiplexed. For another example, the resource pool B1 for SL PRS reception and the SL communication resource pool are frequency-division multiplexed.

In an embodiment, in each slot within the SL PRS resource pool, OFDM symbols for SL PRS-related signal or channel transmission are the same as configuration for SL communication on an SL BWP.

In an embodiment, in each slot within the SL PRS resource pool, OFDM symbols for SL PRS-related signal or channel reception are the same as configuration for SL communication on an SL BWP.

For example, in each slot within the resource pool for SL PRS transmission for the first device, OFDM symbols for SL PRS-related signal or channel transmission are the same as configuration for SL communication on an SL BWP. For another example, in each slot within the resource pool for SL PRS reception for the second device, OFDM symbols for SL PRS-related signal or channel reception are the same as configuration for SL communication on an SL BWP.

In an embodiment, the SL PRS resource pool and an SL BWP where the SL PRS resource pool is located occupy same frequency domain resources. For example, in the case where the SL PRS resource pool occupies the reserved slots, the resource pool for SL PRS transmission and the SL BWP where the resource pool for SL PRS transmission is located occupy same frequency domain resources, or the resource pool for SL PRS reception and the SL BWP where the resource pool for SL PRS reception is located occupy same frequency domain resources.

In an embodiment, in each slot within the SL PRS resource pool, OFDM symbols available for SL PRS-related signal or channel transmission are configured individually.

In an embodiment, in each slot within the SL PRS resource pool, OFDM symbols available for SL PRS-related signal or channel reception are configured individually.

For example, in each slot within the resource pool for SL PRS transmission for the first device, OFDM symbols available for SL PRS-related signal or channel transmission are configured individually. For another example, in each slot within the resource pool for SL PRS reception for the second device, OFDM symbols available for SL PRS-related signal or channel reception are configured individually.

In an embodiment, the SL PRS resource pool occupies the reserved slots and the synchronization signal slots. For example, the resource pool for SL PRS transmission for the first device occupies the reserved slots and the synchronization signal slots. For another example, the resource pool for SL PRS reception for the second device occupies the reserved slots and the synchronization signal slots.

In an embodiment, the SL PRS resource pool occupies OFDM symbols where a physical SL feedback channel (PSFCH) is located in an SL communication resource pool associated with the SL PRS resource pool. For example, the resource pool for SL PRS transmission for the first device occupies OFDM symbols where a PSFCH is located in an SL communication resource pool associated with the resource pool for SL PRS transmission. For another example, the resource pool for SL PRS reception for the second device occupies OFDM symbols where a PSFCH is located in an SL communication resource pool associated with the resource pool for SL PRS reception.

In an embodiment, frequency domain resources contained in the SL PRS resource pool are different from frequency domain resources for PSFCH transmission.

In an embodiment, frequency domain resources contained in the resource pool for SL PRS reception are different from frequency domain resources for PSFCH reception.

For example, frequency domain resources contained in the resource pool for SL PRS transmission for the first device are different from frequency domain resources for PSFCH transmission for the first device. For another example, frequency domain resources contained in the resource pool for SL PRS reception for the second device are different from frequency domain resources for PSFCH reception for the second device.

In an embodiment, configuration of the SL PRS resource pool is independent of configuration of an SL communication resource pool. For example, in the case where time frequency resources occupied by the SL PRS resource pool are different from time frequency resources occupied by an SL communication resource pool, configuration of the SL PRS resource pool may be independent of configuration of the SL communication resource pool. For another example, in the case where the SL PRS resource pool occupies synchronization signal slots, configuration of the SL PRS resource pool may be independent of configuration of an SL communication resource pool.

In an embodiment, the SL PRS resource pool and the SL communication resource pool are configured respectively via different configuration signaling. For example, in the case where configuration of the SL PRS resource pool is independent of configuration of an SL communication resource pool, the SL PRS resource pool may be configured via first configuration signaling, and the SL communication resource pool may be configured via second configuration signaling.

In an embodiment, configuration of the SL PRS resource pool is related to configuration of an SL communication resource pool. For example, in the case where the SL PRS resource pool occupies synchronization signal slots, configuration of the SL PRS resource pool is related to configuration of an SL communication resource pool. For another example, in the case where the SL PRS resource pool occupies reserved slots, configuration of the SL PRS resource pool is related to configuration of an SL communication resource pool. For another example, in the case where the SL PRS resource pool occupies reserved slots and synchronization slots, configuration of the SL PRS resource pool is related to configuration of an SL communication resource pool. For another example, in the case where the SL PRS resource pool occupies OFDM symbols where a PSFCH is located in an SL communication resource pool associated with the SL PRS resource pool, configuration of the SL PRS resource pool is related to configuration of an SL communication resource pool.

In an embodiment, the SL PRS resource pool and the SL communication resource pool are configured together via same configuration signaling. For example, in the case where configuration of the SL PRS resource pool is related to configuration of an SL communication resource pool, the SL PRS resource pool and the SL communication resource pool may be configured together via same configuration signaling. For another example, in the case where configuration of the SL PRS resource pool is related to configuration of an SL communication resource pool, the SL PRS resource pool and the SL communication resource pool may be configured respectively via different configuration signaling, and the configuration signaling of the SL PRS resource pool is no later than the configuration signaling of the SL communication resource pool.

For example, if the SL PRS resource pool occupies reserved slots, the SL PRS resource pool contains some or all of reserved slots configured in a process of determining the SL communication resource pool, where the SL communication resource pool and the SL PRS resource pool are configured together. The PRS resource pool and the SL communication resource pool that are configured together occupy same frequency domain resources.

For example, if the SL PRS resource pool occupies OFDM symbols where a PSFCH is located in an SL communication resource pool associated with the SL PRS resource pool, the PRS resource pool and the SL communication resource pool are configured together, and frequency domain resources contained in the PRS resource pool are different from frequency domain resources for PSFCH transmission.

In embodiments of the disclosure, mutual influence among an SL PRS, an SL signal for SL communication, and an SL channel for SL communication can be avoided, and thus a bandwidth and a frequency for SL PRS transmission can be ensured, so as to improve accuracy of SL-based positioning.

In embodiments of the disclosure, a method for configuring an SL PRS resource is provided, and the method has at least one of the following characteristics. Slots occupied by the SL PRS resource pool are different from slots occupied by the SL communication resource pool, or OFDM symbols occupied by the SL PRS resource pool are different from OFDM symbols occupied by the SL communication resource pool, where the SL PRS resource pool and the SL communication resource pool are on a same BWP. The SL PRS resource pool may occupy reserved slots configured in a process of configuring the SL communication resource pool. The SL PRS resource pool may occupy synchronization signal slots configured on the SL BWP. The SL PRS resource pool may occupy frequency domain resources in PSFCH symbols within the SL communication resource pool.

The method for configuring an SL PRS resource can be performed by any one device in SL communication or can be performed by a network device.

In the following examples, a resource pool for SL PRS transmission is taken as an example for illustration. A manner for configuring a resource pool for SL PRS reception is similar to a manner for configuring the resource pool for SL PRS transmission, and reference can be made to examples of the resource pool for SL PRS transmission.

### Example 1: An SL PRS Resource Pool (PRS Resource Pool for Short) is Configured Individually

In this example, a resource pool for SL PRS transmission and an SL communication resource pool are configured respectively via different configuration signaling. The resource pool for SL PRS transmission may be referred to as a resource pool for SL PRS-related signal or channel transmission. The SL communication resource pool may be referred to as a resource pool for SL communication. Optionally, time frequency resources occupied by the resource pool for SL PRS transmission are different from time frequency resources occupied by the SL communication resource pool. For example, slots contained in the resource pool for SL PRS-related signal or channel transmission are different from slots contained in the SL communication resource pool, and/or the resource pool for PRS-related signal or channel transmission and the SL communication resource pool contain OFDM symbols in a same slot, where OFDM symbols contained in the resource pool for PRS-related signal or channel transmission are different from OFDM symbols contained in the SL communication resource pool. In embodiments of the disclosure, SL PRS-related signal or channel transmission includes PRS-related channel or signal transmission, for example, a control channel indicating sequencing PRS-related signal or channel transmission, and the same statement in the following has the same meaning.

Requirement for SL PRS transmission is different from requirement for PSSCH transmission. For SL PRS transmission, a transmission bandwidth needs to be guaranteed to provide accurate positioning. For PSSCH transmission, adequate time frequency resources are needed to meet a requirement of data rate. For configuration of the resource pool for SL PRS transmission, in a slot, the number of OFDM symbols needed for SL PRS-related signal or channel transmission may be less than the number of OFDM symbols needed for PSSCH transmission, so as to avoid introducing additional AGC time to the slot. Optionally, in any case, time domain resources occupied by the resource pool for PRS-related signal or channel transmission may be different from time domain resources occupied by an SL communication resource pool. In this case, the resource pool for PRS-related signal or channel transmission and the SL communication resource pool cannot be frequency-division multiplexed.

According to an implementation manner of the example, if time domain resources occupied by the resource pool for PRS-related signal or channel transmission are different from time domain resources occupied by any SL communication resource pool, on an SL BWP available for PRS-related signal or channel transmission, in a slot, the starting OFDM symbol of and the length of OFDM symbols available for PRS-related signal or channel transmission are configured individually via dedicated signaling. The SL BWP available for PRS-related signal or channel transmission is referred to as an SL BWP where the SL PRS resource pool is located. In a slot, the OFDM symbols available for PRS-related signal or channel transmission may be different from OFDM symbols for SL communication configured on the SL BWP. On the SL BWP, if multiple resource pools for PRS-related signal or channel transmission are included, different resource pools for PRS-related signal or channel transmission may occupy different frequency domain resources in a same slot or in a same OFDM symbol.

According to an implementation manner of the example, if the time domain resources occupied by the resource pool for PRS-related signal or channel transmission are different from time domain resources occupied by any SL communication resource pool, in a slot contained in any one resource pool available for PRS-related signal or channel transmission, the starting OFDM symbol of and the length of the OFDM symbols available for PRS-related signal or channel transmission are configured individually via dedicated signaling. If multiple resource pools available for PRS-related signal or channel transmission are configured on the SL BWP, different resource pools occupy different time domain resources. By configuring different starting points and lengths, a slot can be configured as different PRS resource pools. As illustrated in FIG. 8, the first 7 OFDM symbols in a slot can be configured as OFDM symbols of the first PRS resource pool, where the starting OFDM symbol is OFDM symbol #0, and the length is 7 symbols. In addition, the last 7 OFDM symbols in the slot can be configured as OFDM symbols of the second PRS resource pool, where the starting OFDM symbol is OFDM symbol #7, and the length is 7 symbols. Optionally, in this case, frequency domain resources occupied by the SL PRS resource pool may be the same as frequency domain resources occupied by the SL BWP where the SL PRS resource pool is located. In this case, signaling for configuring the PRS resource pool does not contain frequency domain resource indication information.

### Example 2: An SL PRS Resource Pool Occupies Reserved Slots

In the example, in any case, the SL PRS resource pool and an SL communication resource pool may be configured together. The SL PRS resource pool may contain some or all of the reserved slots configured in a process of determining the SL communication resource pool configured together with the SL PRS resource pool. For example, if the length of a bitmap for the SL communication resource pool is 160 bits, and 128 slots for synchronization signal transmission are configured in a DFN period, the number of reserved slots is 32. The 32 reserved slots can all be configured as a resource pool for PRS-related signal or channel transmission. In the case where some of the 32 reserved slots can be configured as a PRS resource pool, an additional bitmap is needed to indicate reserved slots that can be configured as the PRS resource pool.

In the example, the SL PRS resource pool and the SL communication resource pool that are configured together may occupy same frequency domain resources. In this case, the SL PRS resource pool and other SL PRS resource pools may be frequency-division multiplexed, or the SL PRS resource pool and the SL communication resource pool may be frequency-division multiplexed. In each slot within the SL PRS resource pool, OFDM symbols for SL-related signal or channel transmission are the same as configuration for SL communication on a current SL BWP. Alternatively, the SL PRS resource pool and an SL BWP where the SL PRS resource pool is located occupy same frequency domain resources. In this case, similar to example 1, in each slot within the PRS resource pool, OFDM symbols available for SL PRS-related signal or channel transmission may be configured individually.

### Example 3: An SL PRS Resource Pool Occupies Synchronization Signal Slots

In the example, the SL PRS resource pool occupies some or all of slots for SL synchronization transmission configured on a current SL BWP.

According to a first implementation manner of the example, the SL PRS resource pool consists of synchronization signal subframes for synchronization signal reception. For example, two synchronization signal slots are configured in each SL synchronization signal transmission period on the current SL BWP. For a specific terminal, the first synchronization signal slot is used for SL synchronization signal transmission, and the second synchronization signal slot is used for SL synchronization signal reception. A terminal that performs PRS transmission (especially a terminal that transmits a PRS for absolute positioning) needs to have accurate positioning and timing information and thus has no need to receive a synchronization signal. Therefore, for the specific terminal, a PRS resource pool may consist of a second synchronization slot in each synchronization period.

According to a second implementation manner of the example, the SL PRS resource pool consists of all synchronization signal subframes. For example, if two synchronization signal slots are configured in each SL synchronization signal transmission period on the current SL BWP, the SL PRS resource pool may consist of two synchronization signal slots in each synchronization period.

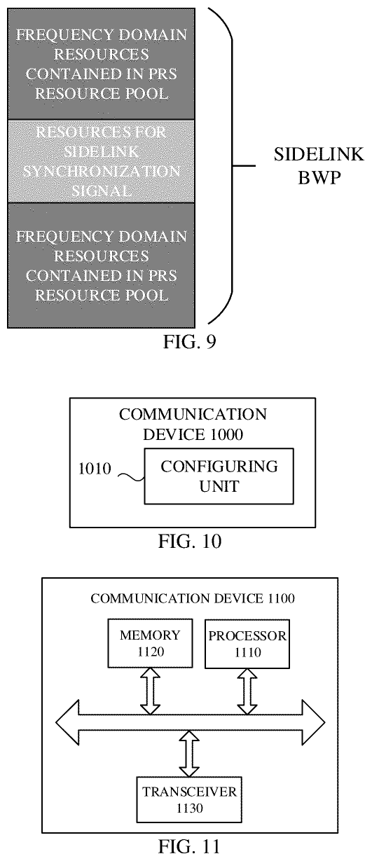

For any one of the implementation manners mentioned above, optionally, as illustrated in FIG. 9, the SL PRS resource pool occupies all frequency domain resources not used for SL synchronization signal transmission configured on the SL BWP where the SL PRS resource pool is located. Moreover, in a slot within the SL PRS resource pool, OFDM symbols available for SL PRS-related signal or channel transmission are the same as configuration for SL communication on the current SL BWP.

### Example 4: An SL PRS Resource Pool Occupies Synchronization Signal Slots and Reserved Slots

In the example, in any case, the SL PRS resource pool and an SL communication resource pool may be configured together. The SL PRS resource pool contains some or all of the reserved slots configured in a process of determining the SL communication resource pool configured together with the SL PRS resource pool, and further contains some or all of the slots for synchronization signal transmission configured on the SL BWP where the SL PRS resource pool is located. For example, if the length of a bitmap for the SL communication resource pool is 160 bits, and 128 slots for synchronization signal transmission are configured in a DFN period, the number of reserved slots is 32. The 32 reserved slots can all be configured as a resource pool for SL PRS-related signal or channel transmission, and two slots for synchronization signal transmission are configured in each SL synchronization signal transmission period on the SL BWP. The 32 reserved slots and two synchronization signal slots in each SL synchronization signal transmission period are configured as the PRS resource pool.

### Example 5: The SL PRS Resource Pool Occupies PSFCH Symbols within an SL Communication Resource Pool Associated with the SL PRS Resource Pool

In the example, in any case, the SL PRS resource pool and an SL communication resource pool may be configured together, and the SL PRS resource pool occupies PSFCH symbols in the SL communication resource pool associated with the SL PRS resource pool. In this case, frequency domain resources contained in the SL PRS resource pool are different from frequency domain resources for PSFCH transmission.

### Example 6: The SL PRS Resource Pool is Configured Individually and May Contain Synchronization Signal Slots

In the example, a resource pool for SL PRS transmission and an SL communication resource pool are configured respectively via different configuration signaling. If slots for synchronization signal transmission are configured on an SL BWP where the SL PRS resource pool is located, some or all of the synchronization slots can be mapped to a bitmap for configuring the SL PRS resource pool.

According to a method for configuring a PRS resource pool provided in embodiments of the disclosure, the SL PRS resource pool and the SL communication resource pool may coexist in a same SL BWP in a time-division manner. For example, slots occupied by the SL PRS resource pool are different from slots occupied by the SL communication resource pool, or OFDM symbols occupied by the SL PRS resource pool are different from OFDM symbols occupied by the SL communication resource pool. For another example, the SL PRS resource pool can occupy reserved slots configured in a process of configuring an SL communication resource pool, or synchronization signal slots configured on the SL BWP, or frequency resources in the PSFCH symbol within the SL communication resource pool.

With the method provided in embodiments of the disclosure, mutual influence among an SL PRS, an SL signal for SL communication, and an SL channel on a same SL BWP can be avoided, and thus a bandwidth and a frequency for SL PRS transmission can be ensured, so as to ensure accuracy of SL-based positioning.

FIG. 10 is a schematic block diagram of a communication device 1000 according to an embodiment of the disclosure. The communication device 1000 includes a configuring unit 1010 configured to configure SL PRS-related information.

In an embodiment, the SL PRS-related information includes at least one of: an SL PRS-related signal, an SL PRS-related channel, or an SL PRS resource pool.

In an embodiment, the SL PRS resource pool includes at least one of: a resource pool for SL PRS transmission, where the resource pool for SL PRS transmission is configured for transmission of the SL PRS-related signal or the SL PRS-related channel, or a resource pool for SL PRS reception, where the resource pool for SL PRS reception is configured for reception of the SL PRS-related signal or the SL PRS-related channel.

In an embodiment, a manner for configuring the SL PRS-related information includes at least one of: configuring by a network device, configuring by a peer device, or pre-configuring.

In an embodiment, time frequency resources occupied by the SL PRS resource pool are different from time frequency resources occupied by an SL communication resource pool.

In an embodiment, slots in the SL PRS resource pool are different from slots in the SL communication resource pool.

In an embodiment, the SL PRS resource pool and the SL communication resource pool contain OFDM symbols in a same slot, where the OFDM symbols in the SL PRS resource pool are different from the OFDM symbols in the SL communication resource pool.

In an embodiment, in a slot, the number of OFDM symbols available for SL PRS-related signal or channel transmission is less than the number of OFDM symbols available for PSSCH transmission.

In an embodiment, in a slot, the number of OFDM symbols available for SL PRS-related signal or channel reception is less than the number of OFDM symbols available for PSSCH reception.

In an embodiment, on an SL BWP where the SL PRS resource pool is located, in a slot, a starting OFDM symbol of and a length of OFDM symbols available for SL PRS-related signal or channel transmission are configured individually via dedicated signaling.

In an embodiment, in a slot, a starting OFDM symbol of and a length of OFDM symbols available for SL PRS-related signal or channel reception are configured individually via dedicated signaling.

In an embodiment, in a slot, OFDM symbols available for SL PRS-related signal or channel transmission are different from OFDM symbols available for SL communication configured on the SL BWP.

In an embodiment, in a slot, OFDM symbols available for SL PRS-related signal or channel reception are different from OFDM symbols available for SL communication configured on the SL BWP.

In an embodiment, in the case where multiple SL PRS resource pools are configured on the SL BWP, different SL PRS resource pools occupy different frequency domain resources in a same slot or a same OFDM symbol.

In an embodiment, in the case where multiple SL PRS resource pools are configured on the SL BWP, different SL PRS resource pools occupy different time domain resources.

In an embodiment, different SL PRS resource pools occupy different OFDM symbols in a same slot, and the different OFDM symbols are configured via parameters for configuring the starting OFDM symbol of and the length of the different OFDM symbols.

In an embodiment, the SL PRS resource pool and the SL BWP where the SL PRS resource pool is located occupy same frequency domain resources.

In an embodiment, the SL PRS resource pool occupies synchronization signal slots.

In an embodiment, the SL PRS resource pool occupies some or all of slots for SL synchronization signal transmission configured on an SL BWP.

In an embodiment, the SL PRS resource pool contains synchronization signal subframes for synchronization signal transmission.

In an embodiment, the SL PRS resource pool occupies some or all of slots for SL synchronization signal reception configured on an SL BWP.

In an embodiment, the SL PRS resource pool contains synchronization signal subframes for synchronization signal reception.

In an embodiment, the SL PRS resource pool contains all synchronization signal subframes.

In an embodiment, the SL PRS resource pool occupies frequency domain resources not used for SL synchronization signal transmission configured on an SL BWP where the SL PRS resource pool is located.

In an embodiment, the SL PRS resource pool occupies frequency domain resources not used for SL synchronization signal reception configured on an SL BWP where the SL PRS resource pool is located.

In an embodiment, in a slot within the SL PRS resource pool, OFDM symbols available for SL PRS-related signal or channel transmission are the same as configuration for SL communication on an SL BWP.

In an embodiment, in a slot within the SL PRS resource pool, OFDM symbols available for SL PRS-related signal or channel reception are the same as configuration for SL communication on an SL BWP.

In an embodiment, in the case where an SL BWP where the SL PRS resource pool is located is configured with synchronization slots for synchronization signal transmission, some or all of the synchronization slots are mapped to a bitmap for configuring the SL PRS resource pool.

In an embodiment, in the case where an SL BWP where the SL PRS resource pool is located is configured with synchronization slots for synchronization signal reception, some or all of the synchronization slots are mapped to a bitmap for configuring the SL PRS resource pool. In an embodiment, the SL PRS resource pool occupies reserved slots.

In an embodiment, the SL PRS resource pool occupies some or all of reserved slots configured in a process of determining an SL communication resource pool.

In an embodiment, in the case where the SL PRS resource pool occupies some of the reserved slots configured in the process of determining the SL communication resource pool, a bitmap for configuring the SL PRS resource pool indicates reserved slots configured for the SL PRS resource pool.

In an embodiment, the SL PRS resource pool and an SL communication resource pool occupy same frequency domain resources.

In an embodiment, at least one of the following is frequency-division multiplexed: different SL PRS resource pools; or, the SL PRS resource pool and the SL communication resource pool.

In an embodiment, in each slot within the SL PRS resource pool, OFDM symbols for SL PRS-related signal or channel transmission are the same as configuration for SL communication on an SL BWP.

In an embodiment, in each slot within the SL PRS resource pool, OFDM symbols for SL PRS-related signal or channel reception are the same as configuration for SL communication on an SL BWP.

In an embodiment, the SL PRS resource pool and an SL BWP where the SL PRS resource pool is located occupy same frequency domain resources.

In an embodiment, in each slot within the SL PRS resource pool, OFDM symbols available for SL PRS-related signal or channel transmission are configured individually.

In an embodiment, in each slot within the SL PRS resource pool, OFDM symbols available for SL PRS-related signal or channel reception are configured individually.

In an embodiment, the SL PRS resource pool occupies OFDM symbols where a PSFCH is located in an SL communication resource pool associated with the SL PRS resource pool.

In an embodiment, frequency domain resources contained in the SL PRS resource pool are different from frequency domain resources for PSFCH transmission.

In an embodiment, configuration of the SL PRS resource pool is independent of configuration of an SL communication resource pool.

In an embodiment, the SL PRS resource pool and the SL communication resource pool are configured respectively via different configuration signaling.

In an embodiment, configuration of the SL PRS resource pool is related to configuration of an SL communication resource pool.

In an embodiment, the SL PRS resource pool and the SL communication resource pool are configured together via same configuration signaling.

The communication device 1000 in embodiments of the disclosure can implement corresponding functions of the communication device in the foregoing embodiments of method 700. For the procedure, function, implementation manner, and advantage corresponding to each module (sub-module, unit, or assembly, etc.) in the communication device 1000, reference can be made to the corresponding illustrations in the foregoing method embodiments, which will not be described in detail again herein. It should be noted that, the functions of various modules (sub-modules, units, or assemblies, etc.) in the communication device 1000 described in embodiments of the disclosure may be implemented by different modules (sub-modules, units, or assemblies, etc.), or may be implemented by the same module (sub-module, unit, or assembly, etc.).

FIG. 11 is a schematic structural diagram of a communication device 1100. The communication device 1100 includes a processor 1110 configured to invoke and run a computer program stored in a memory, so as to enable the communication device 1100 to implement the method in embodiments of the disclosure.

In a possible implementation manner, the communication device 1100 may further include a memory 1120. The processor 1110 can invoke and run a computer program stored in the memory 1120, so as to enable the communication device 1100 to implement the method in embodiments of the disclosure.

The memory 1120 can be a separate device independent of the processor 1110 or can be integrated into the processor 1110.

In a possible implementation manner, the communication device 1100 may further include a transceiver 1130. The processor 1110 can control the transceiver 1130 to communicate with other devices, specifically, to transmit information or data to other devices or to receive information or data transmitted by other devices.

The transceiver 1130 may include a transmitter and a receiver. The transceiver 1130 may further include an antenna, where one or more antennas can be provided.

In a possible implementation manner, the communication device 1100 may be operable as the network device in embodiments of the disclosure, and the communication device 1100 can implement the operations performed by the network device in various methods in embodiments of the disclosure, which will not be repeated herein for the sake of simplicity.

In a possible implementation manner, the communication device 1100 may be operable as the terminal device in embodiments of the disclosure, and the communication device 1100 can implement the operations performed by the terminal device in various methods in embodiments of the disclosure, which will not be repeated herein for the sake of simplicity.

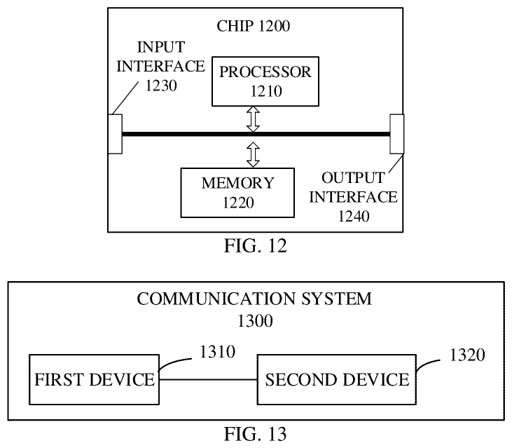

FIG. 12 is a schematic structural diagram of a chip 1200 according to embodiments of the disclosure. The chip 1200 includes a processor 1210. The processor 1210 may invoke and run a computer program stored in a memory, to implement the method in embodiments of the disclosure.

In a possible implementation manner, the chip 1200 may further include a memory 1220. The processor 1210 can invoke and run a computer program stored in the memory 1220, to implement the method performed by a terminal device or a network device.

The memory 1220 may be a separate device independent of the processor 1210 or may be integrated into the processor 1210.

In a possible implementation manner, the chip 1200 may further include an input interface 1230. The processor 1210 can control the input interface 1230 to communicate with other devices or chips, and specifically, to obtain information or data sent by other devices or chips.

In a possible implementation manner, the chip 1200 may further include an output interface 1240. The processor 1210 can control the output interface 1240 to communicate with other devices or chips, and specifically, to output information or data to other devices or chips.

In a possible implementation manner, the chip may be applied to the network device in embodiments of the disclosure, and the chip may implement corresponding operations implemented by the network device in various methods in embodiments of the disclosure, which will not be described again herein for the sake of brevity.

In a possible implementation manner, the chip may be applied to the terminal device in embodiments of the disclosure, and the chip may implement corresponding operations implemented by the terminal device in various methods in embodiments of the disclosure, which will not be described again herein for the sake of brevity.

The chip applied to the network device may be the same as or different from the chip applied to the terminal device.

It is understood, the chip in embodiments of the disclosure may also be a system-on-chip (SOC).

The processor described above may be a general-purpose processor, a digital signal processor (DSP), a field programmable gate array (FPGA), an application specific integrated circuit (ASIC), or other programmable logic devices, discrete gates or transistor logic devices, discrete hardware components, etc. The general-purpose processor may be a microprocessor, or any conventional processor, or the like.

The memory described above may be a volatile memory or a non-volatile memory, or may include both the volatile memory and the non-volatile memory. The non-volatile memory may be a read-only memory (ROM), a programmable ROM (PROM), an erasable PROM (EPROM), an electric EPROM (EEPROM), or a flash memory. The volatile memory can be a random access memory (RAM).

It is understood that, the memory above is intended for illustration rather than limitation. For example, the memory in embodiments of the disclosure may also be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), a direct rambus RAM (DR RAM), etc. In other words, the memory in embodiments of the disclosure is intended to include, but is not limited to, these and any other suitable types of memory.

FIG. 13 is a schematic block diagram of a communication system 1300 according to embodiments of the disclosure. The communication system 1300 includes a first device 1310 and a second device 1320.

The first device 1310 is configured to configure SL PRS-related information.

The second device 1320 is configured to configure the SL PRS-related information.

The first device 1310 may be configured to implement corresponding functions implemented by a first device in the method 700, and the second device 1320 may be configured to implement corresponding functions implemented by a second device in the method 700, which are not repeated herein for the sake of brevity.

In an embodiment, the communication system 1300 may further include a network device. The network device is configured to configure the SL PRS-related information. The network device may be configured to implement corresponding functions implemented by a network device in the method 700, which are not repeated herein for the sake of brevity.

All or some of the above embodiments can be implemented through software, hardware, firmware, or any other combination thereof. When implemented by software, all or some of the above embodiments can be implemented in the form of a computer program product. The computer program product includes one or more computer instructions. When the computer instructions are applied and executed on a computer, all or some of the operations or functions of the embodiments of the disclosure are performed. The computer can be a general-purpose computer, a special-purpose computer, a computer network, or other programmable apparatuses. The computer instruction can be stored in a computer-readable storage medium, or transmitted from one computer-readable storage medium to another computer-readable storage medium. For example, the computer instruction can be transmitted from one website, computer, server, or data center to another website, computer, server, or data center in a wired manner or in a wireless manner. Examples of the wired manner can be a coaxial cable, an optical fiber, a digital subscriber line (DSL), etc. The wireless manner can be, for example, infrared, wireless, microwave, etc. The computer-readable storage medium can be any computer accessible usable-medium or a data storage device such as a server, a data center, or the like which integrates one or more usable media. The usable medium can be a magnetic medium, such as a soft disk, a hard disk, or a magnetic tape); an optical medium, such as a digital video disc (DVD); or a semiconductor medium, such as a solid state disk (SSD), etc.

It is understood that, in various embodiments of the disclosure, the magnitude of a sequence number of each of the foregoing processes does not mean an execution order, and an execution order of each process should be determined according to a function and an internal logic of the process, which shall not constitute any limitation to an embodiment process of embodiments of the disclosure.

It will be evident to those skilled in the art that, for the sake of convenience and simplicity, in terms of the working processes of the foregoing systems, apparatuses, and units, reference can be made to the corresponding processes of the above method embodiments, which will not be repeated herein.

The above are merely specific embodiments of the disclosure and are not intended to limit the scope of protection of the disclosure. Any modification and replacement made by those skilled in the art within the technical scope of the disclosure shall be included in the scope of protection of the disclosure. Therefore, the scope of protection of the disclosure should be stated in the scope of protection of the claims.

What is claimed is:

1. A method for sidelink communication, comprising:
configuring sidelink positioning reference signal (PRS)-related information;
wherein the sidelink PRS-related information comprises at least one of:
a sidelink PRS-related signal or a sidelink PRS-related channel; or
a sidelink PRS resource pool.

2. The method of claim 1, wherein the sidelink PRS resource pool comprises at least one of:
a resource pool for sidelink PRS transmission, wherein the resource pool for sidelink PRS transmission is configured for transmission of the sidelink PRS-related signal or the sidelink PRS-related channel; or
a resource pool for sidelink PRS reception, wherein the resource pool for sidelink PRS reception is configured for reception of the sidelink PRS-related signal or the sidelink PRS-related channel.

3. The method of claim 1, wherein a manner for configuring the sidelink PRS-related information comprises at least one of:
configuring by a network device;
configuring by a peer device; or
pre-configuring.

4. The method of claim 1, wherein time frequency resources occupied by the sidelink PRS resource pool are different from time frequency resources occupied by a sidelink communication resource pool.

5. The method of claim 4, wherein slots in the sidelink PRS resource pool are different from slots in the sidelink communication resource pool.

6. The method of claim 1, wherein the sidelink PRS resource pool and a sidelink BWP where the sidelink PRS resource pool is located occupy same frequency domain resources.

7. The method of claim 1, wherein configuration of the sidelink PRS resource pool is independent of configuration of a sidelink communication resource pool.

8. The method of claim 7, wherein the sidelink PRS resource pool and the sidelink communication resource pool are configured respectively via different configuration signaling.

9. The method of claim 1, wherein configuration of the sidelink PRS resource pool is related to configuration of a sidelink communication resource pool.

10. The method of claim 9, wherein the sidelink PRS resource pool and the sidelink communication resource pool are configured together via same configuration signaling.

11. A communication device, comprising:
a processor; and
a memory storing a computer program which, when executed by the processor, causes the communication device to:
configure sidelink positioning reference signal (PRS)-related information,
wherein the sidelink PRS-related information comprises at least one of:
a sidelink PRS-related signal or a sidelink PRS-related channel; or
a sidelink PRS resource pool.

12. The device of claim 11, wherein the sidelink PRS resource pool comprises at least one of:
a resource pool for sidelink PRS transmission, wherein the resource pool for sidelink PRS transmission is configured for transmission of the sidelink PRS-related signal or the sidelink PRS-related channel; or
a resource pool for sidelink PRS reception, wherein the resource pool for sidelink PRS reception is configured for reception of the sidelink PRS-related signal or the sidelink PRS-related channel.

13. The device of claim 11, wherein a manner for configuring the sidelink PRS-related information comprises at least one of:
configuring by a network device;
configuring by a peer device; or
pre-configuring.

14. The device of claim 11, wherein time frequency resources occupied by the sidelink PRS resource pool are different from time frequency resources occupied by a sidelink communication resource pool.

15. The device of claim 14, wherein slots in the sidelink PRS resource pool are different from slots in the sidelink communication resource pool.

16. The device of claim 11, wherein the sidelink PRS resource pool and a sidelink BWP where the sidelink PRS resource pool is located occupy same frequency domain resources.

17. The device of claim 11, wherein configuration of the sidelink PRS resource pool is independent of configuration of a sidelink communication resource pool.

18. The device of claim 17, wherein the sidelink PRS resource pool and the sidelink communication resource pool are configured respectively via different configuration signaling.

19. The device of claim 11, wherein configuration of the sidelink PRS resource pool is related to configuration of a sidelink communication resource pool.

20. The device of claim 19, wherein the sidelink PRS resource pool and the sidelink communication resource pool are configured together via same configuration signaling.
